(19) United States
(12) Patent Application Publication
(10) Pub. No.: US 2011/0176173 A1
(43) Pub. Date: Jul. 21, 2011

(54) IMAGE PROCESSING APPARATUS

(75) Inventor: Yoshifumi Sakamoto, Osaka City (JP)

(73) Assignee: SANYO ELECTRIC CO., LTD., Moriguchi City (JP)

(21) Appl. No.: 13/009,320

(22) Filed: Jan. 19, 2011

(30) Foreign Application Priority Data
Jan. 19, 2010 (JP) 2010-008673

(51) Int. Cl. G06F 3/12; G06K 9/46

(52) U.S. Cl. 358/1.15; 382/190

(57) ABSTRACT

An image processing apparatus includes an image obtaining unit which obtains image data for each of a plurality of types, and a selection receiving unit which displays the obtained image data and receives selection of one of the displayed image data. The image processing apparatus further includes an image delivery unit which performs a delivery action for delivering the selected image data to the reception device, or a printing unit which generates printed matter of the selected image data.

### CROSS-REFERENCE TO RELATED APPLICATIONS

This nonprovisional application claims priority under 35 U.S.C. §119(a) on Patent Application No. 2010-008673 filed in Japan on Jan. 19, 2010, the entire contents of which are hereby incorporated by reference.

### BACKGROUND OF THE INVENTION

1. Field of the Invention

The present invention relates to an image processing apparatus that provides image information or the like about a movie.

2. Description of Related Art

Conventionally, various services using apparatuses and systems have been designed for enhancing convenience and satisfaction of users (customers) of movie theaters. For instance, there is a service of providing users with information of movies that are being screened, using a display apparatus installed in the movie theater for displaying promotion images of the movies that are being screened, as well as a seat reservation service utilizing the Internet.

According to these services, the users can get information about the movies that are being screened, or can easily make reservation of seats. Note that it is very important to improve satisfaction of users also for management of the movie theater, because it gives users an incentive to visit the movie theater again so that the numbers of users increase.

Contents of movies are focused particularly on visual factors, and it is assumed that most users are strongly interested in images about the movie (e.g., an image of a scene in the movie, or an image for advertizing the movie). Therefore, if a service for providing desired image information or printed matters about the movie is available, it is estimated that satisfaction of users will be improved substantially.

### SUMMARY OF THE INVENTION

The image processing apparatus according to the present invention includes an image obtaining unit which obtains image data for each of a plurality of types, a selection receiving unit which displays the obtained image data and receives selection of one of the displayed image data, a connection unit to which a reception device is connected in a detachable manner, and an image delivery unit which performs a delivery action for delivering the selected image data to the reception device.

Further, an image processing apparatus according to another embodiment of the present invention includes an image obtaining unit which obtains image data for each of a plurality of types, a selection receiving unit which displays the obtained image data and receives selection of one of the displayed image data, a printing unit which generates a printed matter of the selected image data, so as to provide the printed matter.

### BRIEF DESCRIPTION OF THE DRAWINGS

The above-mentioned and other objects and features of the present invention will be apparent from the following description of preferred examples with reference to the attached drawings, which are as follows.

FIG. 1 is an explanatory diagram illustrating a layout of facilities in an example of a movie theater.

FIG. 2 is a block diagram of an image delivery apparatus according to an embodiment of the present invention.

FIG. 3 is an outline diagram of the image delivery apparatus.

FIG. 4 is an explanatory diagram of an image data management table.

FIG. 5 is a flowchart of an image delivery action performed by the image delivery apparatus.

FIG. 6 is a block diagram of a printed matter providing apparatus according to an embodiment of the present invention.

FIG. 7 is an outline diagram of the printed matter providing apparatus.

FIG. 8 is a flowchart of a printed matter providing action performed by the printed matter providing apparatus.

### DETAILED DESCRIPTION OF THE PREFERRED EMBODIMENTS

An image processing apparatus according to an embodiment of the present invention is described below, with reference to Example 1 that is a form of an image delivery apparatus and Example 2 that is a form of a printed matter providing apparatus.

### EXAMPLE 1

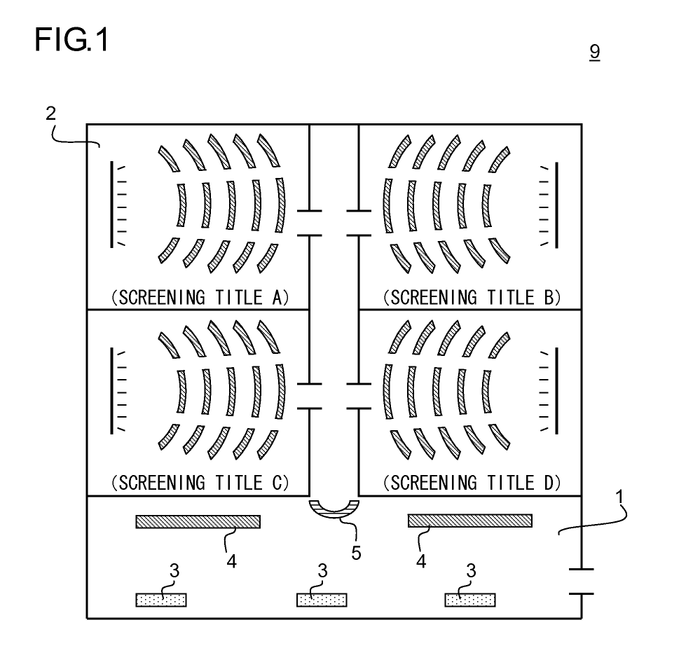

First, as Example 1, an image delivery apparatus (a type of an image processing apparatus) is described. FIG. 1 illustrates a layout of facilities in a movie theater in which the image delivery apparatus is installed. As illustrated in this diagram, a movie theater 9 is provided with an entrance hall 1, and a plurality of (four in this example) screening rooms 2 in which movies are screened. Different titles (A to D) of movies are screened in the screening rooms 2, respectively. In this way, the movie theater 9 has a form that is called a cinema complex.

The entrance hall 1 is a place where users (customers) of the movie theater can enter freely, in which ticket dispensers 3 and image delivery apparatuses 4 are placed. Further, on the passage from the entrance hall 1 to the screening rooms 2, there is a check gate 5 for checking movie tickets (an apparatus having a function of checking movie tickets, or staff of the movie theater 9). In order to see a movie in one of the screening rooms 2, the user is required to by a movie ticket using the ticket dispenser 3 in advance.

The ticket dispenser 3 is an apparatus that issues a movie ticket in exchange for an admission fee or the like. The user can use the ticket dispenser 3 so as to purchase a movie ticket corresponding to a title of the movie that the user wants to see. Note that the movie ticket has information about a title of the movie corresponding to the ticket, running time, the screening room 2 to enter, a position of the sheet (reserved sheet), and the like, so that the user can check the information.

In addition, the movie ticket is accompanied with a predetermined form (e.g., a printed bar code) of information about the movie title and the like corresponding to the ticket so that the image delivery apparatus 4 can read the information. The user presents the movie ticket to the check gate 5 after purchasing the movie ticket, so as to go to the screening room 2.

In addition, the movie ticket may have a form in which a stub for presenting and a stub for carrying are connected. In this case, the user hands the stub for presenting to the check gate 5 and carries the stub for carrying. Note that the user may operate the ticket dispenser 3 directly, or another operator may operate the same.

The image delivery apparatus 4 is an apparatus which delivers image data concerning titles of movies that are screened in the movie theater 9 to a portable terminal carried by the user. A structure and an action of the image delivery apparatus 4 will be described later in detail. Note that the ticket dispenser 3, the image delivery apparatus 4, and an image server that will be described later are administered by an administrator or the like of the movie theater. As described above, a plurality of titles of movies are screened in the movie theater 9, so that the user can see any one of the titles of movies.

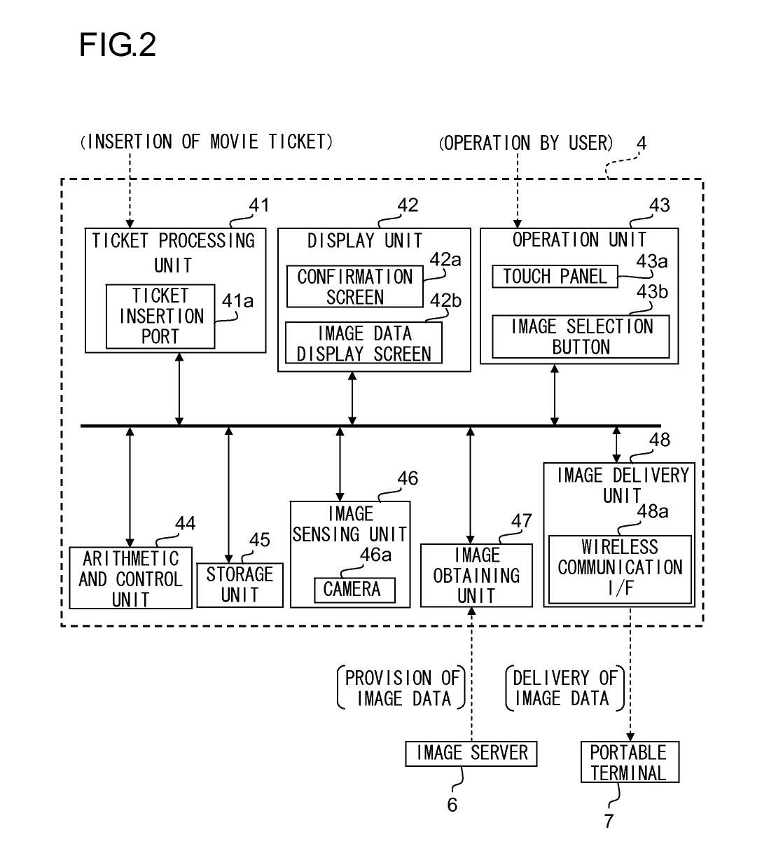

Next, a structure of the image delivery apparatus 4 is described. FIG. 2 is a block diagram illustrating a structure of the image delivery apparatus 4, and FIG. 3 is an outline diagram of the image delivery apparatus 4 (that illustrates the front view thereof). The image delivery apparatus 4 is supposed to be installed appropriately so that the user faces the front side thereof

As illustrated in FIG. 2, the image delivery apparatus 4 includes a ticket processing unit 41, a display unit 42, an operation unit 43, an arithmetic and control unit 44, a storage unit 45, an image sensing unit 46, an image obtaining unit 47, and an image delivery unit 48.

The ticket processing unit 41 is provided with a ticket insertion port 41a that receives a movie ticket (including a case of a stub or the like) inserted by the user. In addition, the ticket processing unit 41 is provided with a device that reads information accompanying with the inserted movie ticket (in particular, information of the movie title corresponding to the ticket), and a device that collects an inserted movie ticket, and the like. Note that the information read from the movie ticket is transmitted to the arithmetic and control unit 44.

The display unit 42 is provided with a confirmation screen 42a that is mainly used for the user to confirm individual information, and an image data display screen 42b that is mainly used for a display of image data. The display unit 42 displays various images on the screens (42a and 42b) in accordance with an instruction from the arithmetic and control unit 44.

Note that the image data display screen 42b is provided for each of six screens S001 to S003 and D001 to D003 as illustrated in FIG. 3. In addition, three screens S001 to S003 are adapted to be suitable for displaying still images, and other three screens D001 to D003 are adapted to be suitable for displaying moving images in particular. However, the screens S001 to S003 and D001 to D003 may have the same specification.

The operation unit 43 is provided with a touch panel 43a disposed on the surface of the confirmation screen 42a, and image selection buttons 43b corresponding to the individual image data display screens 42b. The touch panel 43a is transparent so as not to block a display of the confirmation screen 42a, and detects a position touched by a user's finger or the like and timing thereof The detected results are transmitted to the arithmetic and control unit 44. In addition, when the user presses the image selection button 43b, the result thereof is transmitted to the arithmetic and control unit 44.

The arithmetic and control unit 44 is constituted of a central processing unit (CPU) or the like. The arithmetic and control unit 44 performs control of individual units of the image delivery apparatus 4 and various operation processes, so that the image delivery apparatus 4 acts normally. Note that fundamental actions performed by the image delivery apparatus 4 will be described later.

The storage unit 45 is constituted of a RAM that is used as a working memory, a ROM that stores a predetermined application program and the like in advance, a hard disk drive (HDD) that is used for storing the obtained image data, and the like. The arithmetic and control unit 44 can make access to the storage unit 45. Note that each of the image data obtained by the image delivery apparatus 4 is related to any one of a plurality of titles of movies. Further, the storage unit 45 also stores an image data management table for managing the image data that are currently stored.

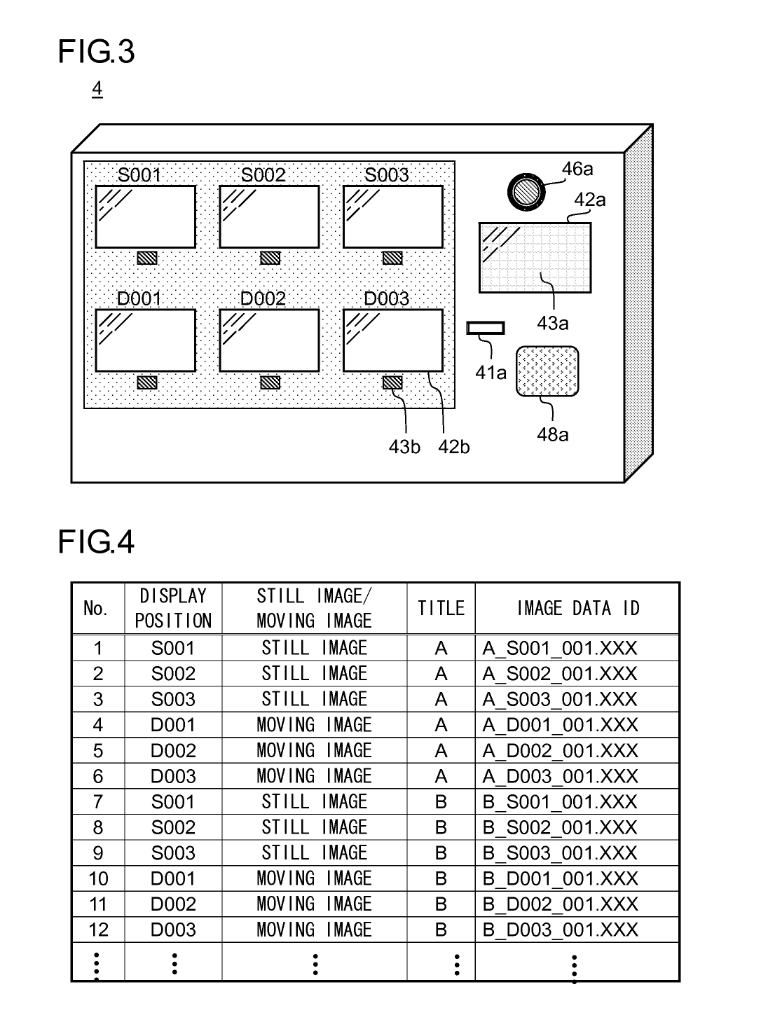

As illustrated in FIG. 4, the image data management table includes information of “display position”, “still image/moving image”, “title”, “image data ID”, and the like for each image data that is currently stored. Note that the item of “display position” indicates which one of positions (screens) S001 to S003 and D001 to D003 the image data should be displayed when it is displayed on the image data display screen 42b.

In addition, the item of “still image/moving image” indicates whether the image data is a still image or a moving image. In addition, the item of “title” indicates a title of the movie corresponding to the image data (that may be an ID or the like assigned to each title). In addition, the item of “image data ID” indicates an ID (e.g., a file name) for distinguishing the image data from other image data.

According to the image data management table illustrated in FIG. 4, the image data of No. 1, for example, is displayed at the position of “S001” when it is displayed on the image data display screen 42b. Further, it is a “still image” corresponding to a title “A” (a scene of a movie having the title A), and its ID is “A S001_{—}001.XXX”.

Note these pieces of information concerning the image data are sent to the image delivery apparatus 4 accompanying with the image data when an image server 6 sends the image data to the image delivery apparatus 4. In this way, the image data sent to the image delivery apparatus 4 is associated with a movie title and the like.

The image sensing unit 46 is equipped with a camera 46a for taking a subject in front of the image delivery apparatus 4 (in particular, it is supposed that the subject is a user who is making access to the image delivery apparatus 4 at present). The image sensing unit 46 takes an image in accordance with an instruction from the arithmetic and control unit 44 so as to obtain taken image data.

The image obtaining unit 47 is connected to the image server 6 (that is an apparatus having a function of transmitting image data to the image delivery apparatus 4 at any time) using USB or LAN, and can communicate with the image server 6. When receiving image data from the image server 6, the image obtaining unit 47 stores the image data in the storage unit 45.

Note that the image data transmitted from the image server 6 to the image delivery apparatus 4 is related to one of a plurality of titles of movies that are screened in the movie theater 9. As the image data related to a title, for example, there is a still image or a moving image representing a scene of the movie of the title, as well as a still image or a moving image for advertizing the movie of the title.

The image delivery unit 48 is equipped with a wireless communication IT 48a that enables wireless communication with a portable terminal 7 when the portable terminal 7 approaches the image delivery unit 48. Here, the portable terminal 7 is a mobile reception device carried by each user, such as a mobile phone or a digital camera, for example. The image delivery unit 48 has a configuration such that the portable terminal 7 can be connected and disconnected in wireless via the wireless communication IT 48a. The image delivery unit 48 delivers (transmits) image data to the connected portable terminal 7 in accordance with an instruction from the arithmetic and control unit 44.

In addition, the image delivery unit 48 has a function of detecting whether or not wireless communication with the portable terminal 7 is available. Not that it is desirable that the wireless communication IT 48a can perform fast information delivery using near field wireless transmission technology (e.g., TransferJet), for example, regardless that the information is a still image or a moving image. In this case, however, it is necessary that the portable terminal 7 also supports the communication using the near field wireless transmission technology.

Next, an action of the image delivery apparatus 4 is described. When the image delivery apparatus 4 is powered on, it performs a predetermined initial process (boot of the CPU, initialization process of individual units, execution of application programs stored in the ROM, and the like), and then moves to a normal action state.

In the normal action state, the image delivery apparatus 4 monitors whether or not the image server 6 has provided one or more types of image data, and whether or not a movie ticket is inserted into the ticket insertion port 41a.

If the image data has been provided, the image obtaining unit 47 stores the provided image data in the storage unit 45. In addition, the image obtaining unit 47 appropriately updates the image data management table (see FIG. 4) described above when the new image data is stored. Thus, the image data management table is maintained to be the latest state.

Note that the provision of image data and storing of the provided image data may be performed so that a whole or a part of the image data stored in the image delivery apparatus 4 is regularly replaced with a new one (old image data is deleted). In this way, it is possible to handle the image data stored in the image delivery apparatus 4 as time-limited data, so as to increase user's desire to obtain.

On the other hand, if a movie ticket is inserted in the ticket insertion port 41a, the arithmetic and control unit 44 decides that the user has requested to deliver image data, and starts an action for delivering image data to the portable terminal 7 carried by the user (the action is referred to as an “image delivery action” for convenience sake).

Note that the inserted movie ticket is collected by the image delivery apparatus 4 and is not returned to the user. Therefore, the image delivery action is performed only once for one movie ticket. In addition, the action of inserting a movie ticket into the ticket insertion port 41 a can be regarded as an action of presenting a movie ticket to the image delivery apparatus 4.

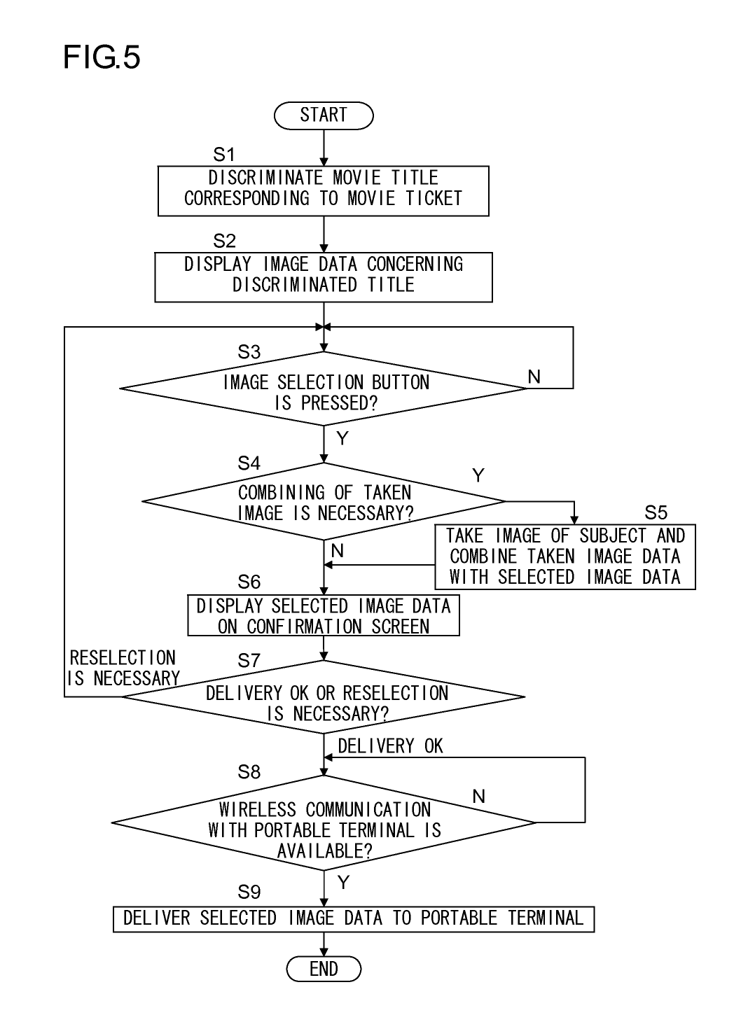

In addition, during the image delivery action, explanations about a procedure of the action of the image delivery apparatus 4 and the action expected for the user are displayed on the confirmation screen 42a or the like as necessary. Details of the image delivery action are described below with reference to the flowchart illustrated in FIG. 5.

First, the image delivery apparatus 4 discriminates a title of the movie corresponding to the movie ticket inserted into the ticket insertion port 41a (Step S1). Further, as described above, the movie ticket is accompanied with title information corresponding to the movie ticket. Therefore, by reading the information, it is possible to perform the discrimination process.

After that, the arithmetic and control unit 44 selects image data associated with (corresponding to) the discriminated title from image data stored in the storage unit 45, with reference to the image data management table. Then, the arithmetic and control unit 44 displays each of the selected image data on the image data display screen 42b (Step S2). Note that it is decided which one of positions S001 to S003 and D001 to D003 each image data is displayed in accordance with information of the “display position” in the image data management table.

In addition, concerning a display form of the image data display screen 42b, if the image data is data of a still image, the state of displaying the still image is kept until the image delivery action of one time is finished, for example. On the contrary, if the image data is data of a moving image, the moving image is displayed repeatedly until the image delivery action of one time is finished, for example.

In addition, in the state where the image data is displayed as described above, the arithmetic and control unit 44 waits either one of image selection buttons 43b being pressed (Step S3). In this case, while seeing the image data display screen 42b, the user can decide the image data to be delivered among the image data that are displayed.

Then, the user presses the image selection button 43b corresponding to the decided image data (i.e., corresponding to the screen in which the image data is displayed), so as to select any one of image data. Hereinafter, the image data that is selected is referred to as “selected image data” for convenience sake.

In addition, the arithmetic and control unit 44 further waits an instruction about necessity or non-necessity of combining the taken image (e.g., a predetermined operation of the touch panel 43a). In this case, if the user wants to combine the taken image (e.g., a portrait of the user) with the image to be delivered (i.e., an image of the selected image data), the user should instruct that combining of the taken image is necessary. Otherwise, the user should instruct that combining of the taken image is not necessary.

When the instruction indicating that combining of the taken image is necessary is issued (Y in Step S4), the arithmetic and control unit 44 controls the image sensing unit 46 to take an image of a subject with the camera 46a so that taken image data is obtained. Note that the procedure of the action of taking an image is adapted so that the taken image data desired by the user can be obtained easily.

For instance, the image taken with the camera 46a is displayed on the confirmation screen 42a in real time so that the user can check. In addition, an image taken at a predetermined timing that the user can prepare (e.g., the timing when the user performs a predetermined operation or the timing that the user can expect from a countdown display) is adopted as the taken image data.

When the taken image data is obtained in this way, the arithmetic and control unit 44 combines the taken image data with the selected image data so as to generate a combined image data (Step S5). More specifically, if the selected image data is a still image, the image of the taken image data is overlaid on a part of the still image so as to obtain the combined image data. In addition, if the selected image data is a moving image, the image of the taken image data is overlaid on the same position of each frame of the moving image so as to obtain the combined image data.

Further, in this case, a part regarded as a background in the taken image data (e.g., a white color part in the taken image data with a white color wall as a background) may be transparent (so that the selected image data can be seen). In addition, the above-mentioned form of the combined image data is merely an example, and other form may be adopted as long as contents of the taken image data are reflected on the selected image data.

In addition, after the combined image data is generated, or when the instruction indicating that combining of the taken image is not necessary is issued (N in Step S4), the arithmetic and control unit 44 controls the confirmation screen 42a to display the selected image data (hereinafter, indicating the combined image data if the combined image data is generated) (Step S6). Thus, the user can check contents of the image data to be delivered for confirmation.

In the state where the selected image data is displayed, the arithmetic and control unit 44 waits an instruction indicating which one of delivery of the selected image data and reception of reselection of image data should be performed (e.g., a predetermined operation of the touch panel 43a) (Step S7). In this case, if the user thinks that the data to be delivered can be the currently selected image data, the user should instruct to perform the delivery (delivery OK). On the contrary, if the user wants to change the selected image data, the user should instruct to receive reselection (reselection is necessary).

When the instruction to receive reselection is issued (“reselection is necessary” in Step S7), the arithmetic and control unit 44 cancels information about the currently selected image data and performs the action in Step S3 again. Thus, the user can change the selected image data.

On the contrary, when the instruction to perform the delivery is issued (“delivery OK” in Step S7), the arithmetic and control unit 44 instructs the image delivery unit 48 to deliver the selected image data to the portable terminal 7. In accordance with this, the image delivery unit 48 waits wireless communication with the portable terminal 7 being enabled (Step S8). In this case, the user puts his or her own portable terminal 7 close to the wireless communication I/F 48a so that the wireless communication becomes enabled.

When the wireless communication becomes enabled, the image delivery unit 48 performs the necessary connection process and the like, and delivers the selected image data to the portable terminal 7 (Step S9). Thus, the selected image data is stored in the storage device of the portable terminal 7. After that, the user can freely see the delivered image data utilizing an image reproducing function or the like of the portable terminal 7.

Note that the image delivery apparatus 4 delivers the selected image data only to one portable terminal 7 for one action of delivering the selected image data. In addition, when the action of Step S9 is completed, the image delivery action of one time is completed, and the image delivery apparatus 4 returned to the normal action state again.

Further, instead of the action of Step S8, it is possible to adopt a structure in which delivery of the selected image data is performed when the user issues the instruction to start the delivery. In this case, the user first puts the portable terminal 7 close to the wireless communication I/F 48a so that the delivery of image data can be performed and issues the instruction to start the delivery.

The image delivery apparatus 4 performs the action as described above. In addition, the administrator of the movie theater 9 can provide the image delivery service to customers who bought movie tickets, using the image delivery apparatus 4. Thus, after buying a movie ticket corresponding to a movie title, the user can receive the delivery of desired image data about the title using the image delivery apparatus 4.

As described above, the image delivery apparatus 4 includes a function portion which obtains image data about a movie (image data of a scene of a movie) for each of a plurality of types (mainly, the image obtaining unit 47 and the like), a function portion which displays the obtained image data and receives selection of one of the displayed image data (mainly, the operation unit 43, the arithmetic and control unit 44, and the like), a function portion to which the portable terminal 7 (one type of the reception device) is connected in a detachable manner (mainly, the image delivery unit 48 and the like), and a function portion which performs the action of delivering the selected image data to the portable terminal 7 (mainly, the arithmetic and control unit 44, and the image delivery unit 48).

Therefore, according to the image delivery apparatus 4, it is possible to deliver desired image data to the portable terminal 7 carried by the user so as to provide the user with desired image information about the movie. Thus, user's satisfaction can be enhanced, so that user's desire to visit the movie theater again is stimulated, and that the number of users can be increased.

In addition, the image delivery apparatus 4 is adapted to perform the action of delivering the selected image data after collecting the movie ticket only one time when the movie ticket is inserted (presented).

Therefore, according to the image delivery apparatus 4, it is possible to limit so that the selected image data is delivered only one time when the movie is seen one time. Thus, it is possible to prevent the delivery from being performed to a person who has not seen the movie yet (has not obtained the movie ticket) or from being performed repeatedly to the same person. In other words, the number of times of the delivery is restricted. As a result, the scarcity value of the image data to be delivered can be maintained as much as possible, while promotion effect for the movie ticket can be expected.

Further, in the image delivery apparatus 4, the image obtaining unit 47 obtains image data related to each of the plurality of titles of movies. In addition, according to the action in Step S1, the title corresponding to the movie ticket (one of the plurality of titles) is specified on the basis of information accompanying with the movie ticket every time when the movie ticket is inserted. Further, according to the action in Steps S2 and S3, the image obtaining unit 47 displays only one of the obtained image data associated with the specified title, and receives selection of any one of the displayed image data.

Therefore, according to the image delivery apparatus 4, it can limit the type of image data to be delivered to that related to the title the user has seen (or intends to see) while it obtains image data of a plurality of titles.

Further, the image delivery apparatus 4 includes a function portion which takes an image of a subject so as to obtain taken image data (mainly, the image sensing unit 46 and the like), and a function portion which combines the taken image data with the selected image data by the action in Step S3 (mainly, the arithmetic and control unit 44 and the like).

Therefore, according to the image delivery apparatus 4, it is possible that the delivered image data is a combination with a portrait of the user, or the like. As a result, contents of the delivered image data can be more close to the user's desire, so that the user's satisfaction can be enhanced more.

Further, in this example, the presented movie ticket is collected so that the number of times of delivery of image data is restricted, but other method may be used for restricting the number of times of delivery of image data.

For instance, if each of the movie tickets is accompanied with ID information (that enables to distinguish the movie ticket from other movie tickets, such as a bar code indicating a serial number), when the movie ticket is presented, the image delivery apparatus 4 reads the ID information and stores the same. Then, in the image delivery apparatus 4, when the movie ticket is presented, it is decided whether or not the ID information accompanying with the presented movie ticket is the same as that of the movie ticket that is presented before.

Further, in the image delivery apparatus 4, only when it is decided that ID information are not the same, the selected image data is delivered only one time. In other words, if the movie ticket that is the same as that presented before is presented again, the action of delivering the selected image data is not performed.

In this way, it is possible to prevent the situation of delivering image data a plurality of times when the same movie ticket is presented repeatedly. Therefore, in the same manner as the case of collecting the movie ticket, it is possible to limit the number of times of delivery.

Note that the thing that is presented to the image delivery apparatus 4 is not limited to the movie ticket. It may be various things that can specify the user who is provided with the delivery (e.g., a card or the like such as a member card or a point card). In this way, it is possible to prevent the situation where an unspecified person can receive the delivery of image data freely. Thus, it is possible to prevent the scarcity value of the image data from being deteriorated as much as possible.

### EXAMPLE 2

Next, Example 2 is described with reference to a printed matter providing apparatus (a type of image processing apparatus). Note that this example is basically the same as Example 1 except for that a printing unit is provided instead of the image delivery unit 48, and that printed matter is delivered instead of image data, an overlapping description is omitted.

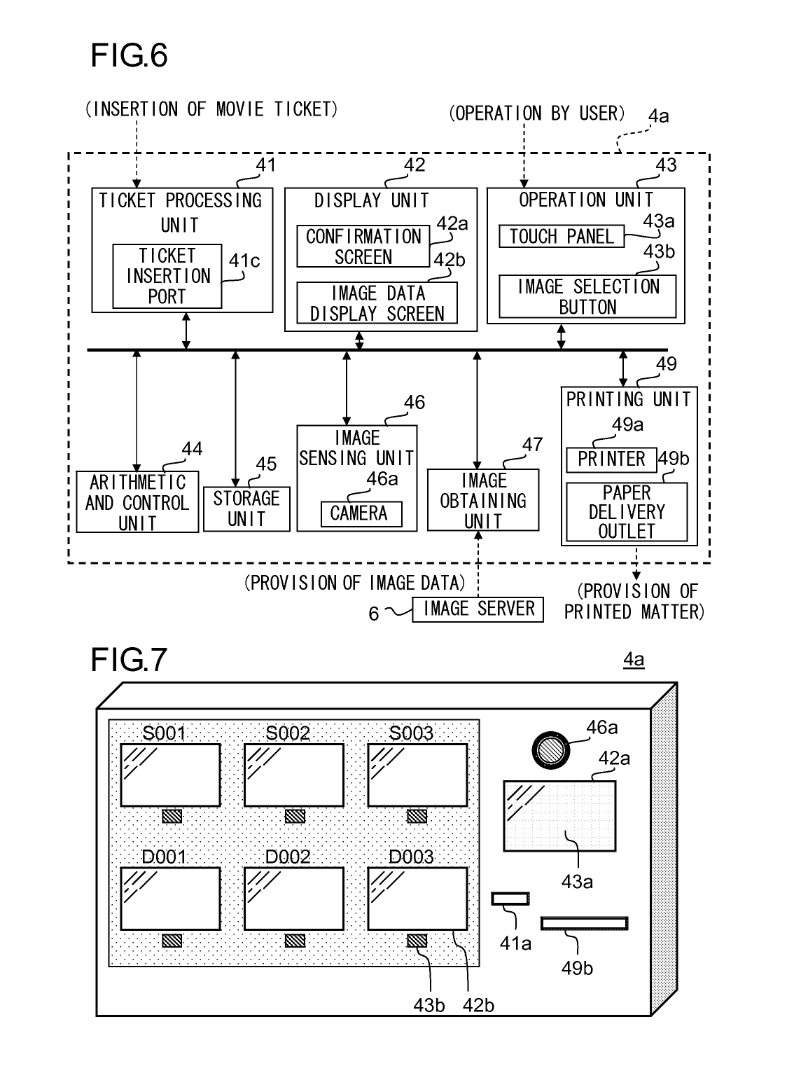

FIG. 6 is a block diagram illustrating a structure of the printed matter providing apparatus according to this example, and FIG. 7 is a diagram illustrating an outline of the printed matter providing apparatus. As illustrated in FIG. 6, the printed matter providing apparatus 4a is provided with a printing unit 49.

The printing unit 49 includes a printer 49a which prints image data on printing paper supplied in advance in accordance with an instruction from the arithmetic and control unit 44, and a paper delivery outlet 49b for delivering a paper sheet on which the printing is performed (a type of the printed matter). As illustrated in FIG. 7, the paper delivery outlet 49b is disposed in the front face of the printed matter providing apparatus 4a, so that the user can receive the delivered paper sheet.

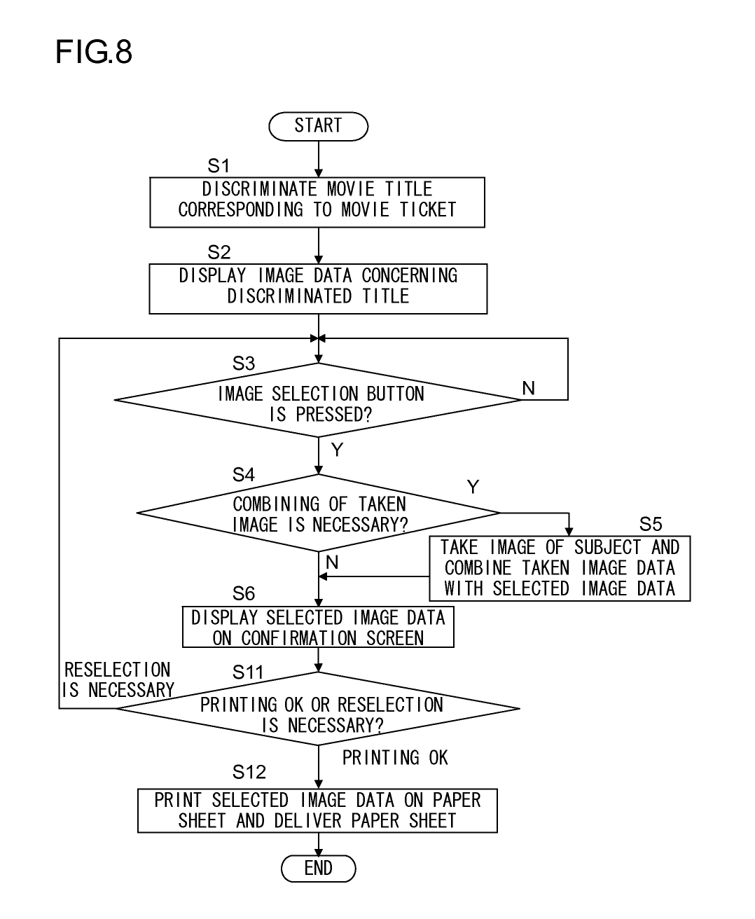

In addition, the printed matter providing apparatus 4a performs an action of providing the paper sheet on which image data is printed (printed matter providing action) instead of the image delivery action performed by the image delivery apparatus 4 in Example 1. The printed matter providing action is described below with reference to a flowchart illustrated in FIG. 8. Note that the actions in Steps S1 to S6 are the same as those in Example 1, so the description thereof is omitted.

In the state where the selected image data is displayed by the action in Step S6, the arithmetic and control unit 44 waits an instruction indicating which one of printing of the selected image data and reception of reselection of image data should be performed (e.g., a predetermined operation using the touch panel 43a) (Step S11). In this case, if the user thinks that the data to be printed should be the currently selected image data, the user should instruct to perform the printing (printing OK); if the user wants to change the selected image data, the user should instruct to receive reselection (reselection is necessary).

When the instruction to receive reselection is issued (“reselection is necessary” in Step S11), the arithmetic and control unit 44 cancels information about the currently selected image data, and performs the action in Step S3 again. Thus, the user can change the selected image data.

When the instruction to perform the printing is issued (“printing OK” in Step S11), the arithmetic and control unit 44 instructs the printing unit 49 to print the selected image data on printing paper and deliver the printed paper. In accordance with this, the printing unit 49 prints the selected image data on the printing paper and delivers the printed paper externally (Step S12). Note that if the selected image data is a moving image, an image of a frame (e.g., a first frame) of the moving image is printed on the printing paper.

Thus, the user can obtain the paper on which the selected image data is printed. Note that the printed matter providing action of one time is finished when the action in Step S12 is finished. Then, the printed matter providing apparatus 4a returns to the normal action state again.

As described above, according to the printed matter providing apparatus 4a, it is possible to provide the user with printed matter of a desired image concerning the movie. Thus, user's satisfaction can be enhanced, so that the number of users can be increased. Note that the medium on which the image data is printed is not limited to printing paper, but it may be various media on which printing can be performed.

In addition, the printed matter providing apparatus 4a may also have the functions described above in Example 1 (such as the function of delivering the selected image data to the portable terminal 7). In this case, it may be configured so that one of the delivery of selected image data and delivery of printed matter is performed in accordance with an instruction from the user, for example.

Although the embodiment of the present invention is described above, the present invention is not limited to this embodiment. In addition, the embodiment of the present invention can be modified variously within the scope of the present invention without deviating from the spirit thereof

What is claimed is:

1. An image processing apparatus comprising:
an image obtaining unit which obtains image data for each of a plurality of types;
a selection receiving unit which displays the obtained image data and receives selection of one of the displayed image data;
a connection unit to which a reception device is connected in a detachable manner, and
an image delivery unit which performs a delivery action for delivering the selected image data to the reception device.

2. An image processing apparatus according to claim 1, wherein when a predetermined ticket is presented, the delivery action is performed only one time after collecting the ticket.

3. An image processing apparatus according to claim 2, wherein
the image obtaining unit obtains image data each of which is associated with one of the plurality of titles of movies,
when the ticket is presented, one of the titles is specified on the basis of information accompanying with the ticket, and
the selection receiving unit displays only image data associated with the specified title among the obtained image data, and receives selection of one of the displayed image data.

4. The image processing apparatus according to claim 1, wherein when a predetermined ticket accompanied with ID information is presented, the delivery action is performed only one time if the ID information is not the same as that presented before.

5. An image processing apparatus comprising:
an image obtaining unit which obtains image data for each of a plurality of types;
a selection receiving unit which displays the obtained image data and receives selection of one of the displayed image data; and
a printing unit which generates printed matter of the selected image data, so as to provide the printed matter.

6. An image processing apparatus according to claim 1, further comprising:
an image sensing unit which takes an image of a subject so as to obtain taken image data; and
a combining unit which combines the taken image data with the selected image data.

7. An image processing apparatus according to claim 5, further comprising:
an image sensing unit which takes an image of a subject so as to obtain taken image data; and
a combining unit which combines the taken image data with the selected image data.
